(19) United States
(12) Patent Application Publication
(10) Pub. No.: US 2007/0066435 A1
(43) Pub. Date: Mar. 22, 2007

(54) Oil pressure control apparatus for an automatic transmission

(75) Inventors: Kiyoharu Takagi, Okazaki-shi (JP); Osamu Sakamoto, Handa-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/522,901

(22) Filed: Sep. 19, 2006

(30) Foreign Application Priority Data
Sep. 22, 2005 (JP) 2005-276461

(51) Int. Cl. F16H 31/00

(52) U.S. Cl. 475/127

(57) ABSTRACT

An oil pressure control apparatus includes: a first latch circuit for maintaining a predetermined shift valve by oil pressure outputted through a first control valve when a predetermined high shift stage is established; and a second latch circuit for maintaining a predetermined shift valve by oil pressure outputted from the first corresponding control valve when a predetermined shift stage for a vehicle restart is established. In an automatic shift pattern, each control valve is operated to achieve an automatic shift mode by which a shift stage in the transmission is freely selected among plural forward shift stages. In the fixed shift pattern, an oil passage for supplying oil pressure of the hydraulic power source to a predetermined control valve via each shift valve is established to achieve a fixed shift mode by which a predetermined fixed forward shift stage is selected in the transmission.

### CROSS REFERENCE TO RELATED APPLICATIONS

This application is based on and claims priority under 35 U.S.C. §119 with respect to Japanese Patent Application 2005-276461, filed on Sep. 22, 2005, the entire content of which is incorporated herein by reference.

### FIELD OF THE INVENTION

The present invention relates to an oil pressure control apparatus for an automatic transmission, in which a level of oil pressure supplied from a hydraulic power source is controlled directly by a servo solenoid valve. The servo solenoid valve is hereinafter referred to as a linear solenoid valve or a solenoid valve.

### BACKGROUND

Japanese examined patent publication (Kokoku) No.5-63664 discloses therein a control apparatus for a transmission, the apparatus which is provided with solenoid valves at the same number as frictional engagement elements and enables to selectively establish six forward shift stages in the transmission. The transmission is incorporated therein with five frictional engagement elements C1, C2, C3, C4 and C5, and the control apparatus includes therein: five solenoid valves, such as linear solenoid valves, for use in the frictional engagement elements C1-C5 respectively; a single ON/OFF solenoid valve; and two shift valves. In the event of a disconnection failure, e.g., when a breakage of a wire occurs or when an electric supply to a wire is discontinued, a shift stage in the transmission is automatically switched in response to a current shift stage at which a vehicle is running. For example, a shift change is carried out: from the 1st shift stage to the 3rd shift stage; to the 4th shift stage from the 2nd, 3rd, 4th or 5th shift stage; and from the 6th stage to the 5th shift stage.

Japanese Patent No.2925505 discloses therein a transmission control apparatus. The transmission is incorporated therein with five frictional engagement elements, and the control apparatus includes therein: two solenoid valves; three shift valves; and three ON/OFF solenoid valves for controlling the shift valves respectively. The transmission control apparatus enables to selectively establish six forward shift stages in the transmission. In this transmission control apparatus, a shift operation is implemented by introducing a line pressure to each frictional engagement element, which serves as a reaction element, and by switching engagement and disengagement of each frictional engagement element in response to operation of the solenoid valves. In the event of a disconnection failure, e.g., when a breakage of a wire occurs or when an electric supply to a wire is discontinued, a shift stage in the transmission is controlled at a predetermined shift stage except for the first and sixth shift stage or at a shift stage higher than the predetermined shift stage.

The transmission control apparatus disclosed in Japanese Patent No.2925505 does not enable a jumping shift operation (hereinafter referred to as a skip shift operation) such as an up/down shift operation between the 3rd shift stage and the 5th shift stage, and an up/down shift operation in order of the 2nd shift stage, the 4th shift stage, and the 6th shift stage. Accordingly, when an up/down shift operation between the 3rh and 5th shift stages should be implemented in the transmission, a shift operation needs to be changed by a single shift stage such as an up/down shift operation in order of the 3rd shift stage, the 4th shift stage and the 5th shift stage. In this case, an operator may obtain an impression such as an excessive amount of shift operation, response degradation, or the like.

In the light of the above, the inventors of Japanese Patent No.2925505 invented in U.S. Pat. No. 6,585,617 an electro-hydraulic control mechanism for a power transmission, a control mechanism which includes therein four linear solenoid valves, two shift valves, a single ON/OFF solenoid valve. The control mechanism further includes a single oil pressure switch which was not provided in the transmission control apparatus in Japanese Patent No.2925505. As a whole, compared with the quantity of the components in the transmission control apparatus disclosed in Japanese Patent No.2925505, in the electro-hydraulic control mechanism disclosed in U.S. Pat. No. 6,585,617, the two linear solenoid valves were added, the one shift valve was omitted, the two ON/OFF solenoid valves were omitted, and the one oil pressure switch was added. With the above-described structure, the electro-hydraulic control mechanism achieves a skip shift operation among the 2nd to 6th shift stages. The oil pressure switch is hereinafter referred to as an oil pressure SW.

According to the conventional works described above, a skip shift operation is achieved by use of the limited number of linear solenoid valves. Meanwhile, the conventional works each address a disconnection failure, i.e., an electric power supply disconnection, and yet does not address improvement of durability against second and/or third failure and to prevent interlocking, and so on.

Moreover, as for an automatic transmission, in which six forward shift stages are selectively established, as described above, or in which seven or more forward shift stages are selectively established, recent requirements have led to lowering downshift feeling in the event of an electric disconnection at all lines while a vehicle is traveling at a high shift stage and to assuring a driving force needed for a restart of a vehicle. With regard to this matter, for example as disclosed in Japanese Patent No.2925505, even if an electric disconnection (disconnection failure) occurs while a vehicle is running at the 1st, 2nd, or 3rd shift stage, the vehicle can run at the 3rd shift stage. Likewise, the 5th shift stage is selected for a vehicle running at the 4th, 5th, or 6th shift stage, and the 3rd shift stage is selected for a vehicle to be started again, i.e., when an ignition switch is changed from the OFF stage to the ON stage. Here, a residual pressure, which is generated by a difference in diameters of two orifices positioned on an oil passage that is employed at a time of the 4th, 5th or 6th shift stage, is utilized for the purpose of retaining the shift valves at positions for the 5th shift stage. In this case, a shift stage in the transmission may be undesirably downshifted to the 3rd shift stage.

Japanese Patent Application Publication No.2001-90829 discloses a control apparatus for an automatic transmission, an apparatus which is incorporated with a failsafe shift valve VA, a high speed gear position storage shift valve VB and a high speed gear position storage cancel shift valve VC. The control apparatus for the automatic transmission enables a vehicle driving at the 3rd shift stage in the event of an electric disconnection while a vehicle is running at the 1st, 2nd or 3rd shift stage. Likewise, the 6th shift stage is selected for a vehicle running at the 4th, 5th or 6th shift stage, despite of an electric disconnection failure. However, in the event of a primary failure of the failsafe shift valve VA, if an electric disconnection occurs during the vehicle running at the 4th, 5th or 6th shift stage, there is a possibility that the 6th shift stage may not be maintained in the transmission. Therefore, these components, which are employed only at a time of failure, may cause an extra manufacturing cost.

The present invention has been made in view of the above circumstances, and provides an oil pressure control apparatus for an automatic transmission, which achieves a skip shift operation with a shift valve and enables selecting a shift stage appropriate for a vehicle environment in the event of a disconnection failure. These should be achieved economically and reliably.

### SUMMARY OF THE INVENTION

According to an aspect of the present invention, an oil pressure control apparatus for an automatic transmission including a plurality of frictional engagement elements engaged and disengaged so as to establish plural forward shift stages in combination of engagement and disengagement of the frictional engagement elements, the oil pressure control apparatus includes: a hydraulic power source for supplying oil pressure; control valves for regulating a level of oil pressure supplied from the hydraulic power source and allocated for at least one corresponding frictional engagement element from among the frictional engagement elements, each control valve including an exhaust port for draining oil pressure supplied from the hydraulic power source and an output port for outputting oil pressure supplied from the hydraulic power source; and a plurality of shift valves shifted ON and OFF for selectively establishing an oil passage between each control valve and the corresponding frictional engagement element, wherein engagement and disengagement of the frictional engagement elements are controlled. Combinations of the ON and OFF states of the shift valves are allocated for an automatic shift pattern and a fixed shift pattern. In the automatic shift pattern, each control valve is operated so as to achieve an automatic shift mode by which a shift stage established in the transmission is freely selected from among the plural forward shift stages. In the fixed shift pattern, an oil passage for supplying oil pressure of the hydraulic power source to an exhaust port of a predetermined control valve from among the control valves via each shift valve is established so as to achieve a fixed shift mode by which a predetermined fixed forward shift stage is selected in the transmission. The oil pressure control apparatus further includes: a first latch circuit for maintaining a first predetermined shift valve from among the shift valves at a predetermined state by the oil pressure outputted through an output port of a first corresponding control valve from among the control valves when a predetermined high shift stage is established; and a second latch circuit for maintaining a second predetermined shift valve from among the shift valves at a predetermined state by the oil pressure outputted through an output port of the first corresponding control valve when a predetermined shift stage for a vehicle restart is established.

### BRIEF DESCRIPTION OF THE DRAWINGS

The foregoing and additional features and characteristics of the present invention will become more apparent from the following detailed description considered with reference to the accompanying drawings, wherein:

FIG. 1 is a block view illustrating an oil pressure circuit of an oil pressure control apparatus for an automatic transmission according to a first embodiment of the present invention;

FIG. 2 is a view illustrating a detailed structure having a latch circuit 22 and a third latch 23, both of which latch a shift valve SV2 to the ON (◯) side;

FIG. 3 is a view illustrating a modified structure of the structure illustrated in FIG. 2;

FIG. 4 is a view illustrating another modified structure of the structure illustrated in FIG. 2;

FIG. 5 is a view illustrating still another modified structure of the structure illustrated in FIG. 2;

FIG. 6 is a view illustrating an oil pressure circuit of an oil pressure control apparatus for an automatic transmission according to a second embodiment of the present invention;

FIG. 7 is a view illustrating a detailed structure having a shuttle valve 11 and a latch circuit 24 according to the second embodiment of the present invention;

FIG. 8 is a view illustrating an oil pressure circuit of an oil pressure control apparatus for an automatic transmission according to a third embodiment of the present invention;

FIG. 9 is a view illustrating an operation of the oil pressure circuit illustrated in FIG. 8 at the event of electric disconnection failure while a vehicle is running at the 4th-6th shift stage at the D range;

FIG. 10 is a view illustrating an operation of the oil pressure circuit illustrated in FIG. 8 at the event of electric disconnection failure while a vehicle is running at the 1th-3th shift stage at the D range;

FIG. 11 is a view illustrating an operation of the oil pressure circuit illustrated in FIG. 8 at the event of electric disconnection failure while a vehicle is running at the 5th shift range;

FIG. 12 is a view illustrating an operation of the oil pressure circuit illustrated in FIG. 8 at the event of electric disconnection failure while a vehicle is running at the 3rd shift range; and

FIG. 13 is a view illustrating an operation of the oil pressure circuit illustrated in FIG. 8 at the event of electric disconnection failure while a vehicle is running at the L-range.

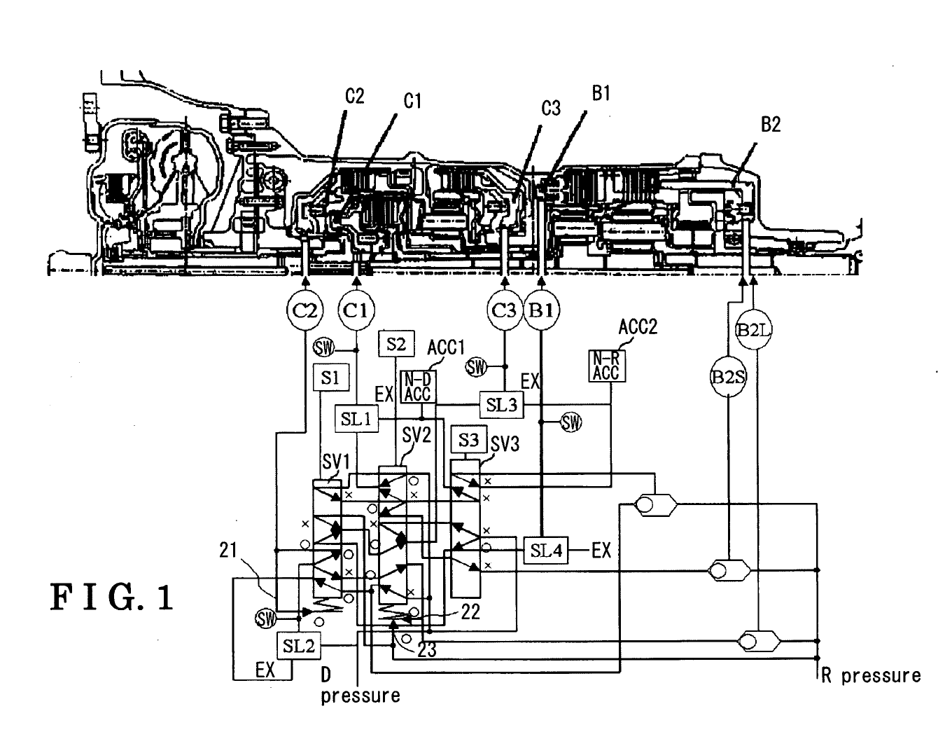

### DETAILED DESCRIPTION

Embodiments of the present invention will be described below with reference to the attached drawings.

### First Embodiment

An oil pressure control apparatus for an automatic transmission according to a first embodiment of the present invention incorporates, therein, a hydraulic power source, an ECU (Electronic Control Unit, not illustrated), three shift valves, which are each denoted with SV1, SV2 and SV3, three ON/OFF solenoid valves, which are each denoted with S1, S2 and S3. As is obvious from D-range of Table 1, in combination of operation of the solenoid valves S1, S2 and S3, eight forward shift patterns, which are prescribed by the third power of two (2³), are supplied. Two of the eight forward shift patterns are assigned to a multiple shift pattern (D 2-6 in Table 1) and to a lower shift stage shift pattern (D 1-2 in Table 1), respectively. When the multiple shift stage shift pattern (D 2-6) is selected, a skip shift operation is enabled. On the other hand, when the lower shift stage shift pattern is selected, a shift operation is implemented at lower shift stages. The other six shift patterns are each assigned to fixed shift stages.

Table 1, described below, summarizes a relationship of the frictional engagement elements C1, C2, C3, B1, B2L and B2S and the linear solenoid valves SL1, SL2 and SL3 relative to each shift pattern established by the solenoid valves S1, S2 and S3. NH and NL in parenthesis each represent a type of linear solenoid valve: NH represents a normally high-type linear solenoid valve that is maintained at an engaged condition in the event of electric disconnection; and NL represents a normally low-type linear solenoid valve that is shifted to a disengaged condition in the event of electric disconnection.

TABLE 1

| | | ON/ | | | | | | | | | |
|---|---|---|---|---|---|---|---|---|---|---|---|
| | | OFF | | | | | | | | | |
| | | SOL | | | CLUTCH | | | BRAKE | | | All SL |
| | | S1 | S2 | S3 | C1 | C2 | C3 | B1 | B2L | B2S | disconnected |
| D | 1-2 | X | ◯ | ◯ | SL1(NL) | | | SL4(NL) | SL2(NH) | | N(B2L) |
| | 2-6 | ◯ | ◯ | ◯ | SL1(NL) | SL2(NH) | SL3(NH) | SL4(NL) | | | 5TH |
| | 1 | X | ◯ | X | SL1 ↑ | | | | SL2(NH) | D pressure | 1ST |
| | 2 | X | X | ◯ | SL1(NL) | | | SL4(NL) | | | N |
| | 3 | X | X | X | SL1 ↑ | | SL3 ↑ | | | | 3RD |
| | 4 | ◯ | ◯ | X | SL1(NL) | SL2(NH) | | | | | N(C2) |
| | 5 | ◯ | X | X | | SL2 ↑ | SL3 ↑ | | | | 5TH |
| | 6 | ◯ | X | ◯ | | SL2 ↑ | | SL4(NL) | | | N(C2) |

| | | | | | | |
|---|---|---|---|---|---|---|
| R | X | ◯ | SL3(NH) | R pressure | R pressure | N(B2) |
| | X | X | SL3 ↑ | R pressure | R pressure | R |
| | ◯ | X | SL3X ↓ | R pressure | R pressure | N(B2) |
| | ◯ | X | SL3◯ ↑ | R pressure | R pressure | |
| | ◯ | ◯ | | R pressure | R pressure | N(B2) |
| N | | | | | | N |

The oil pressure control apparatus for the automatic transmission enables six forward shift stages with the five frictional engagement elements engaged and disengaged. When the lower shift stage shift pattern (D 1-2) is selected, the three linear solenoid valves SL1, SL2 and SL4 from among the four linear solenoid valves are selected to be controlled so that an up/down shift operation between the 1st and 2nd shift stages is implemented. When the multi shift stage shift pattern (D 2-6), in which a skip shift operation is enabled, is selected, all the four linear solenoid valves (control valves) SL1, SL2, SL3 and SL4 are selected to be controlled so that any shift operation among the 2nd to the 6th shift stages is implemented. When a fixed shift pattern is selected, such as the 1st shift stage, the 2nd shift stage, the 3rd shift stage, the 4th shift stage, the 5th shift stage, and the 6th shift stage (D1-D6 of Table 1), corresponding two linear solenoid valves from among the four linear solenoid valves SL1, SL2, SL3 and SL4 are automatically selected to be controlled so as to establish each corresponding fixed shift stage.

The linear solenoid valves SL1, SL3 and SL4 are controlled exclusively for actuation of the clutch C1, the clutch C3 and the brake B1, respectively. Only the linear solenoid valve SL2 is shared for actuation of the clutch C2 and the brake B2. The clutch C2 or the brake B2 is selectively actuated by changing an output oil passage by the linear solenoid valve SL2. The clutch C1, the clutch C2, the clutch C3, the brake B1 and the brake B2 here represent the frictional engagement elements.

Regarding a combination of types of the linear solenoid valves SL1, SL2, SL3 and SL4, the linear solenoid valve SL1 for exclusive use in the clutch C1 is a normally low type (NL), the linear solenoid valve SL2 used for respectively activating the clutch C2 and the brake B2 is a normally high type (NH), the linear solenoid SL3 for exclusive use in the clutch C3 is a normally high type (NH), and the linear solenoid valve SL4 for exclusive use in the brake B1 is a normally low type (NL). Therefore, in the event of an electric disconnection failure at all lines during a vehicle running at the D-range, the linear solenoid valves SL1 (NL) and the linear solenoid valve SL3 (NH) are forced to be activated so that a vehicle can run at the 3rd shift stage with the activated solenoid valves SL1 (NL) SL3 (NH).

A first latch circuit 21 is connected to a compression coil spring chamber at one end of the shift valve SV1 (first predetermined shift valve) so as to introduce an output pressure of the linear solenoid valve SL2 (first corresponding control valve) to the shift valve SV1. A second latch circuit 22 is connected to a compression coil spring chamber at one end of the shift valve SV2 (second predetermined shift valve) so as to introduce an output pressure of the linear solenoid valve SL2 to the shift valve SV2. Therefore, as is explained in Table 1, in the event of an electric disconnection at all lines during a vehicle driving at the 1st shift stage, the vehicle running is effectively retained at the current shift stage, in this case at the 1st shift stage, by operating or latching the shift valve SV1 to the ON (◯) side. Further, in the event of an electric disconnection at all lines during a vehicle running at the 5th shift stage, the vehicle running is effectively retained at the current shift stage, in this case at the 5th shift stage, by operating or latching the shift valve SV2 to the ON (◯) side.

The compression coil spring chamber at the one end of the shift valve SV2 is further connected with a third latch circuit 23 so as to introduce an R pressure (reverse range pressure) to the shift valve SV2 (third predetermined shift valve). As a result, when the reverse range is selected, the shift valve SV2 is maintained at the ON (◯) side so that oil pressure is supplied to a supply port of the linear solenoid valve SL3.

According to the above-described oil passage structure, even when an ON-failure occurs to the linear solenoid valve SL1 (NL), selecting the fixed shift pattern of one of the 1st, 2nd, 3rd and 4th fixed shift stages addresses a secondary failure of other linear solenoid valves.

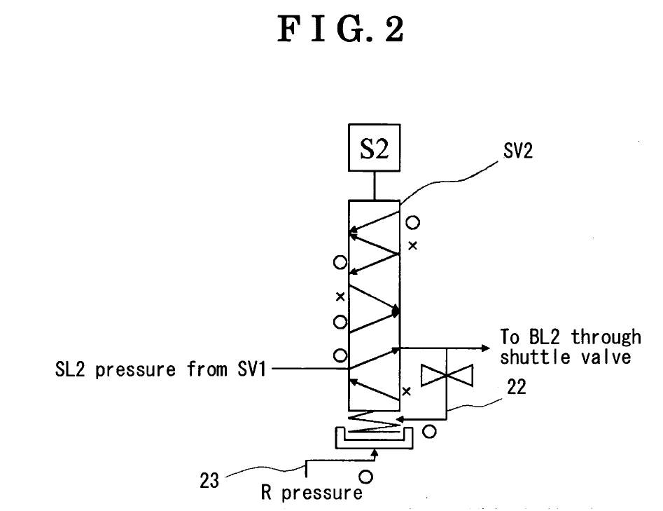

As is illustrated in FIG. 2, the shift valve SV2 includes a configuration in which the R-pressure is controlled so as to communicate with the outside of the compression coil spring chamber, and in which an output pressure of the linear solenoid valve SL 2 via the shift valve SV1 is controlled so as to communicate with the inside of the compression coil spring chamber via a switching circuit of the shift valve SV2 at the second switching circuit from the bottom (hereinafter referred to as second bottom switching circuit). Therefore, a valve body of the shift valve SV2 is maintained at the ON (◯) state when the R-range is selected, or when a 1-2 automatic shift mode or the first fixed shift stage mode is selected, in each of which the solenoid valves S1 and S2 are at the OFF (X) and ON (◯) states respectively. As a result, because the shift valve SV2 is maintained at the ON (◯) state in favor of the output pressure of the linear solenoid valve SL2 even when electric disconnection occurs at all lines during a vehicle running at the 1st shift stage, a vehicle start is effectively performed not at the 3rd shift stage but at the 1st shift stage.

Likewise, also when a vehicle is stopped temporarily, the 1st shift stage is retained in the transmission unless a shift mode is switched from the D-range to another range or unless an ignition switch (IG) is turned ON. Even if the ignition switch (IG) is turned ON, or if an OFF-failure occurs at the linear solenoid valve SL2, a vehicle can run at the 3rd shift stage.

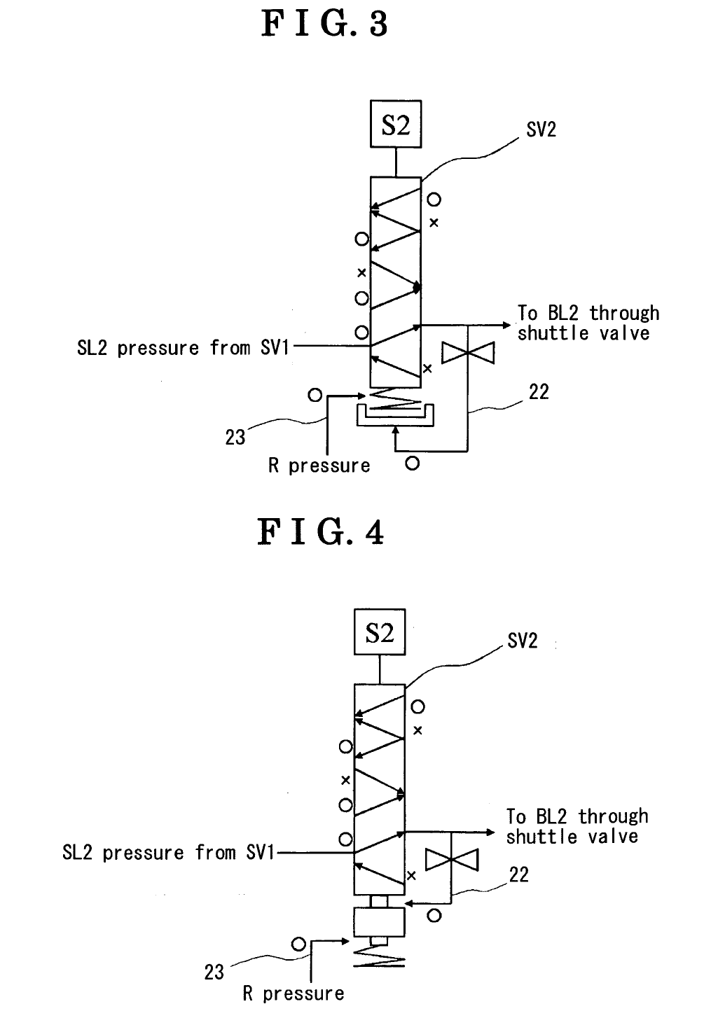

According to the first embodiment of the present invention, the valve body of the shift valve SV2 is not provided with steps, an occurrence of valve sticking is effectively prevented. As illustrated in FIG. 3, the shift valve SV2 possesses a configuration in which the R-pressure is controlled so as to communicate with the inside of the compression coil spring chamber, and in which an output pressure of the linear solenoid valve SL2 via the shift valve SV1 is controlled so as to communicate with the outside of the compression coil spring chamber via the second bottom switching circuit of the shift valve SV2. The shift valve SV2 illustrated in FIG. 3 is a modified mode of the shift valve SV2 illustrated in FIG. 2. The shift valve in FIG. 3 operates in the same manner as the one in FIG. 2 and effectively avoids an occurrence of valve sticking.

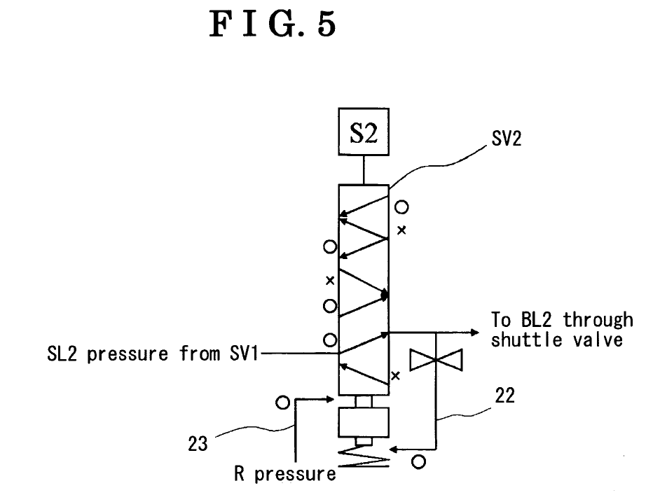

FIGS. 4 and 5 each illustrates a modified configuration of the shift valves SV2 illustrated in FIG. 2. The shift valves SV2 in FIGS. 4 and 5 are each additionally provided with a separated-type small valve (small valve body). Likewise as FIG. 2, a valve body of the shift valve SV2 is latched, and an occurrence of valve sticking is avoided. In FIG. 4, the R-pressure is controlled to communicate with the outside of the small valve, and the output oil passage of the linear solenoid valve SL2 communicates with the inside of the small valve. To the contrary, in FIG. 5, the R-pressure is controlled to communicate with the inside of the small valve, and the output oil passage of the linear solenoid valve SL2 communicates with the outside of the small valve. The other structure of the shift valve SV2 in FIG. 4 is the same as the one in FIG. 5.

As described above, according to the first embodiment of the present invention, even if electric disconnection occurs at all lines in a condition where driving force is necessary, there is no worry about a loss of driving force, and a vehicle running can be maintained at the 1st shift stage. Further, as described above, an occurrence of valve sticking is effectively avoided, and so interlocking is prevented. Still further, the 3rd shift stage is maintained in the transmission during a vehicle running at the 2nd or 3rd shift stage, and the 5th shift stage is maintained in the transmission during a vehicle running at the 4th, 5th or 6th shift stage. Therefore, even if electric disconnection occurs at all lines when a vehicle starts or when a vehicle is driven at a lower or higher shift stage, a shift stage, which is appropriate for a vehicle environment, is effectively assured in the transmission. Oil passages, which are necessary for achieving the above, are added to a structure of a conventional oil pressure control apparatus according to which a skip shift operation is implemented. In other words, although oil passages are added for the purpose of achieving the above, a skip shift operation is still effectively carried out by the oil pressure control apparatus of the first embodiment. Therefore, the above-structure of the oil pressure control apparatus is economically effective.

### Second Embodiment

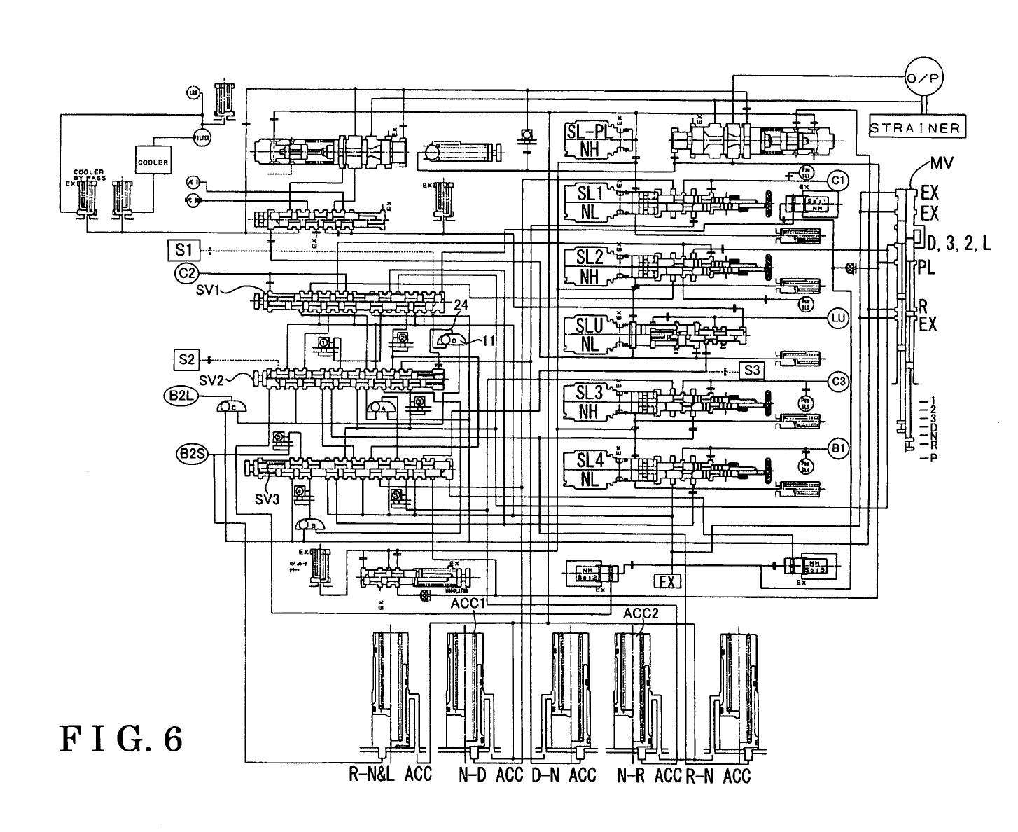

An oil pressure control apparatus for a transmission according to a second embodiment is established by making some minor changes to the first embodiment and is described as follows with the attached drawings. FIG. 6 is a view illustrating an oil pressure circuit of the second embodiment, an oil pressure circuit which is configured by adding a release shock reducing accumulator (R-N&L ACC, D-N ACC, R-N ACC) to the oil pressure circuit of the first embodiment. The fundamental structure of the oil pressure circuit of the second embodiment is the same as the one of the first embodiment.

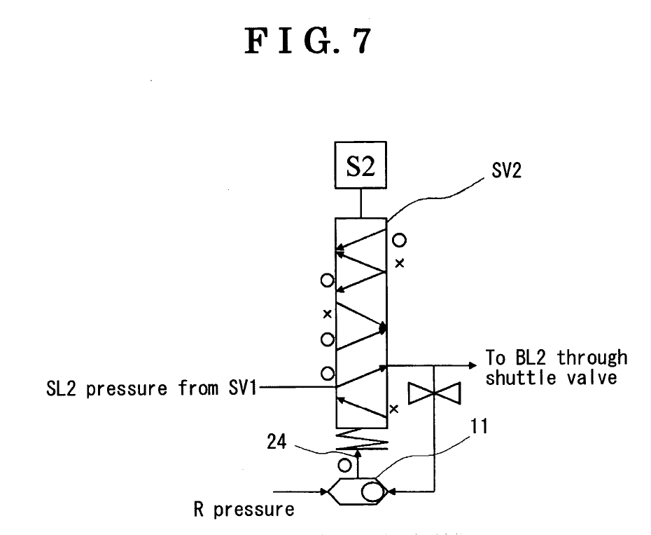

FIG. 7 illustrates a shuttle valve 11 communicating with the compression coil spring chamber of the shift valve SV2 in FIG. 6 and a latch circuit 24. Here, the R-pressure or the output pressure of the linear solenoid valve SL2 is selectively fed to the compression coil spring chamber via the shuttle valve 11. As the pressure is outputted, the shift valve SV2 is latched to the ON (◯) side. On this point, the shift valve SV2 in FIG. 7 is operated in the same manner as the ones illustrated in FIGS. 2 to 5. Therefore, as well as the first embodiment, even if electric disconnection occurs at all lines in a condition where a driving force is necessary, a vehicle running can be maintained at the 1st shift stage, with a simplified oil passage structure.

### Third Embodiment

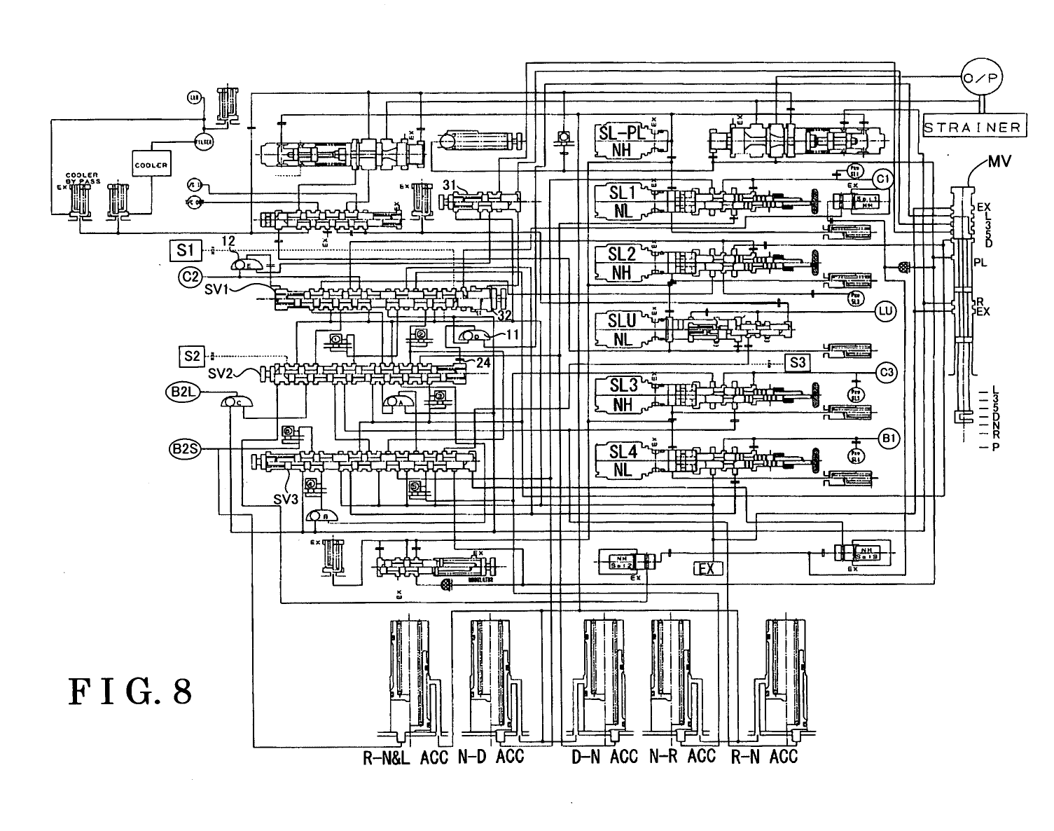

An oil pressure control apparatus for a transmission according to a third embodiment is established by adding a change valve; a shuttle valve and a separated-type small valve and by making some minor changes to a manual valve, relative to the oil pressure control apparatus according to the second embodiment. FIG. 8 illustrates an oil pressure circuit diagram of the oil pressure control apparatus according to the third embodiment. Table 2, described below, summarizes a relationship of the frictional engagement elements and the linear solenoid valves relative to each shift pattern established by the solenoid valves. NH and NL in parenthesis each represents of a type of linear solenoid valve.

TABLE 2

| | | |
|---|---|---|
| ON/ | | |
| OFF | | |
| SOL | CLUTCH | BRAKE |

| | | S1 | S2 | S3 | C1 | C2 | C3 | B1 | B2L | B2S | L/U |
|---|---|---|---|---|---|---|---|---|---|---|---|
| D | 1-2 | X | ◯ | ◯ | SL1(NL) | | | SL4(NL) | SL2(NH) | | SLU(NL) |
| | 2-6 | ◯ | ◯ | ◯ | SL1(NL) | SL2(NH) | SL3(NH) | SL4(NL) | | | SLU(NL) |
| | 1 | X | ◯ | X | SL1 ↑ | | | | SL2(NH) | | |
| | 2 | X | X | ◯ | SL1(NL) | | | SL4(NL) | | | SLU(NL) |
| | 3 | X | X | X | SL1 ↑ | | SL3 ↑ | | | | |
| | 4 | ◯ | ◯ | X | SL1(NL) | SL2(NH) | | | | | |
| | 5 | ◯ | X | X | | SL2 ↑ | SL3 ↑ | | | | |
| | 6 | ◯ | X | ◯ | | SL2 ↑ | | SL4(NL) | | | SLU(NL) |

| | | | | | | |
|---|---|---|---|---|---|---|
| R | X | ◯ | SL3(NH) | R pressure | R pressure | SLU(NL) |
| | X | X | SL3 ↑ | R pressure | R pressure | |
| | ◯ | X | SL3X ↓ | R pressure | R pressure | |
| | ◯ | X | SL3∘ ↑ | R pressure | R pressure | |
| | ◯ | ◯ | | R pressure | R pressure | SLU(NL) |
| N | | X | | | | |
| | | ◯ | | | | SLU(NL) |

*Patterns of upper three rows of D-range (D 1-2, 2-6, 1) are for normal (not failed) condition
**Patterns of lower five rows of D-range (D 2, 3, 4, 5, 6) are for failed condition
***Patterns of upper two rows of R-range are for normal (not failed) condition
****Patterns of lowest row of R-range is for failed condition
*****Patterns of lowest row of N-range is for normal (not failed) condition.

As is apparent from FIG. 8, the manual valve MV of the third embodiment is structured to output L-range pressure, the 3rd range pressure and the 5th range pressure as he D-pressure (forward drive range pressure). The oil pressure control apparatus is provided with a change valve 31, a shuttle valve 12, a small valve 32 arranged at an opposite side of the shift valve SV1 to the compression coil spring chamber, i.e., at the right side of the shift valve SV1 in FIG. 8.

The change valve 31 communicates with an output port of the 3rd range pressure of the manual valve MV and is operatively associated with a level of the 3rd range pressure. The shuttle valve 12 is structured so as to introduce either the output pressure of the linear solenoid valve SL2 or the 5th range pressure traveled through the change valve 31 to the compression coil spring chamber of the shift valve SV1. The small valve 32 operates so as to shift the shift valve SV1 to the OFF (X) side when the third range pressure, which has traveled through the change valve 31, is inputted into the compression coil spring chamber.

Described below is an operation of the oil pressure control apparatus at the time of a disconnection failure. The operation thereof will be described below under each driving range and a vehicle-driving environment.

[Vehicle Driving in 4th-6th of the D Range Under an Automatic Shift Mode]

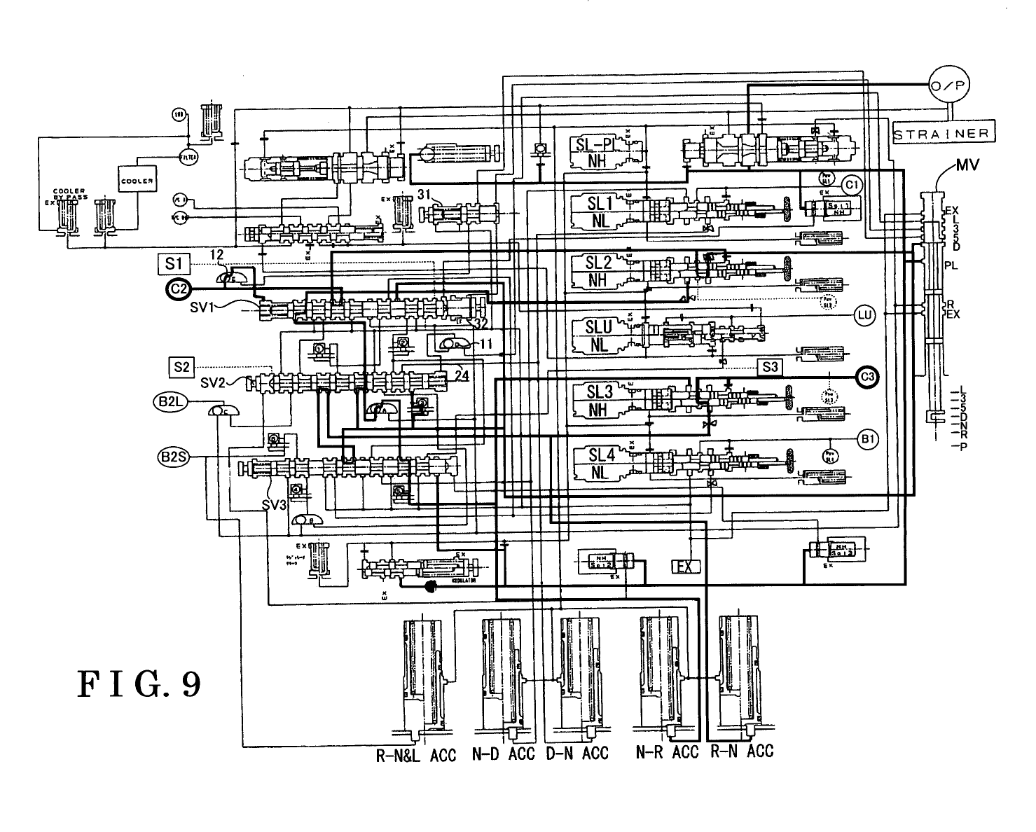

FIG. 9 illustrates a state of the oil passage configuration in which electric disconnection occurs at all lines while a vehicle is running in the 4th-6th shift stage of the D range under an automatic shift mode, i.e., while the solenoid valves S1, S2 and S3 are each at the ON (◯) state. As depicted by bold lines in FIG. 9, the D-range pressure of the manual valve MV is constantly supplied to the supply port of the linear solenoid valve SL2. The oil pressure outputted of the linear solenoid valve SL2 is supplied to the clutch C2 via the shift valve SV1 and is introduced to the compression coil spring chamber of the shift valve SV1 via the shuttle valve 12 so as to latch the shift valve SV1 to the ON (◯) side.

Although the solenoid valves S2 and S3 are both switched from the ON (◯) state to the OFF (X) state, the D-range pressure, which has traveled through the shift valves SV2 and SV3, is supplied to the supply port of the linear solenoid valve SL3, and so the oil pressure outputted of the linear solenoid valve SL3 is supplied to the clutch C3.

As described above, the clutch C2 (SL2) and the clutch C3 (SL3) are both engaged so that the 5th shift stage is established in the transmission. Therefore, even if electric disconnection occurs at all lines while a vehicle is running in 4th-6th shift stage of the D-range under the automatic shift mode, a vehicle running can be continued at the 5th shift stage.

[Vehicle Driving in 1st-3rd of the D Range Under an Automatic Shift Mode]

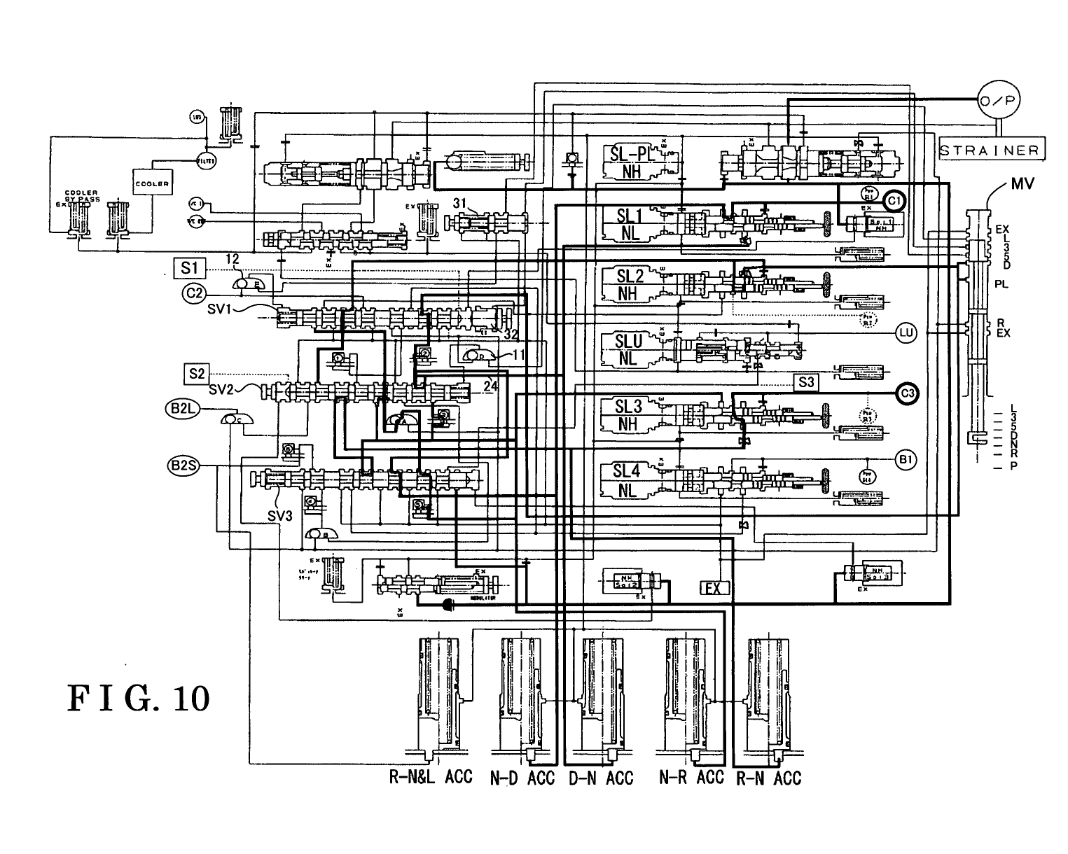

FIG. 10 illustrates a state of the oil passage configuration in which electric disconnection occurs at all lines while a vehicle is running under an automatic shift mode in the 1st-3rd shift stage of the D range, i.e., while the solenoid valves S2 and S3 are each at the ON (◯) state. As depicted by bold lines in FIG. 10, the D-range pressure of the manual valve MV is constantly supplied to the supply port of the linear solenoid valve SL2. Because oil pressure is not supplied to the clutch C2 during the automatic shift mode in the 1st-3rd shift stage of the D range, the shift valve SV1 is not latched to the ON (◯) side of the shift valve SV1, and all the solenoid valves S1, S2 and S3 are controlled to the OFF (X) state. Therefore, the D-range pressure, which has traveled the shift valves SV2 and SV3, is supplied to the supply port of the linear solenoid valve SL3.

Meanwhile, the D-range pressure is supplied to the exhaust port of the linear solenoid valve SL1 after filling in the D-N ACC via the shift valves SV1 and SV2. Further, the D-range pressure is supplied to the exhaust port of the linear solenoid valve SL1 after filling in the N-D ACC via the shift valves SV1 and SV3 so that a frictional engagement of the clutch C1 is forced.

As described above, the clutch C1 (SL1) and the clutch C3 (SL3) are both engaged so that the 3rd shift stage is established in the transmission. Therefore, even if electric disconnection occurs at all lines while a vehicle is running under the automatic shift mode in 1st-3rd shift stage of the D-range, a vehicle running can be continued at the 3rd shift stage.

[Vehicle Driving at the 5th Shift Range]

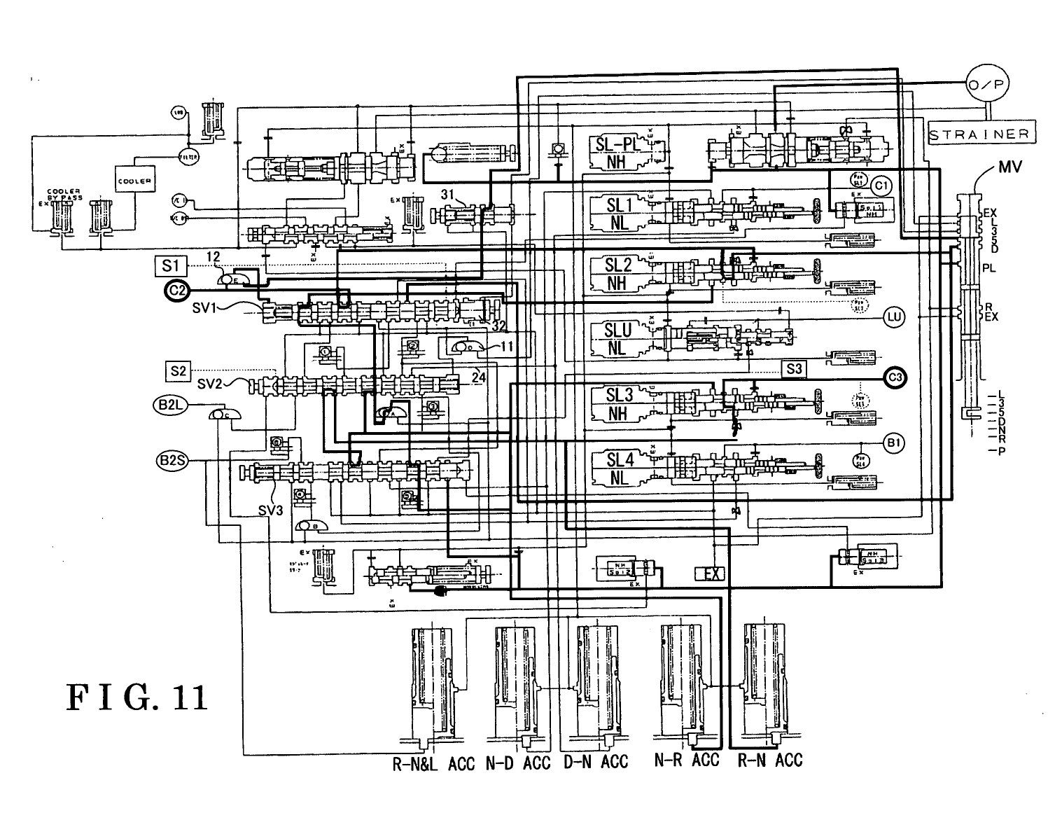

FIG. 11 illustrates a state of the oil passage configuration in which electric disconnection occurs at all lines while a vehicle is running at the 5th shift range, i.e., while the solenoid valve S1 is at the ON (◯) state and the solenoid valves S2 and S3 are each at the OFF (X) state. As depicted by bold lines in FIG. 11, the manual valve MV outputs not only the D-range pressure but also the 5th range pressure. The 5th range pressure, which has traveled through the change valve 31, is fed to the compression coil spring chamber of the shift valve SV1 via the shuttle valve 12 so that the shift valve SV1 is latched to the ON (◯) side.

Therefore, even while electric supply is disconnected at all lines, the solenoid valve S1 is retained at the ON (◯) state; and the solenoid valves S2 and S3 are each retained at the OFF (X) state. Further, as depicted by bold lines in FIG. 11, the D-range pressure outputted from the manual valve MV keeps being supplied to the clutch C2 and the clutch C3.

As described above, the clutch C2 (SL2) and the clutch C3 (SL3) are both engaged so that the 5th shift stage is established in the transmission. Therefore, even if electric disconnection occurs at all lines while a vehicle is running at the 5th shift stage, a vehicle running can be continued at the 5th shift stage.

[Vehicle Driving at the 3rd Shift Range]

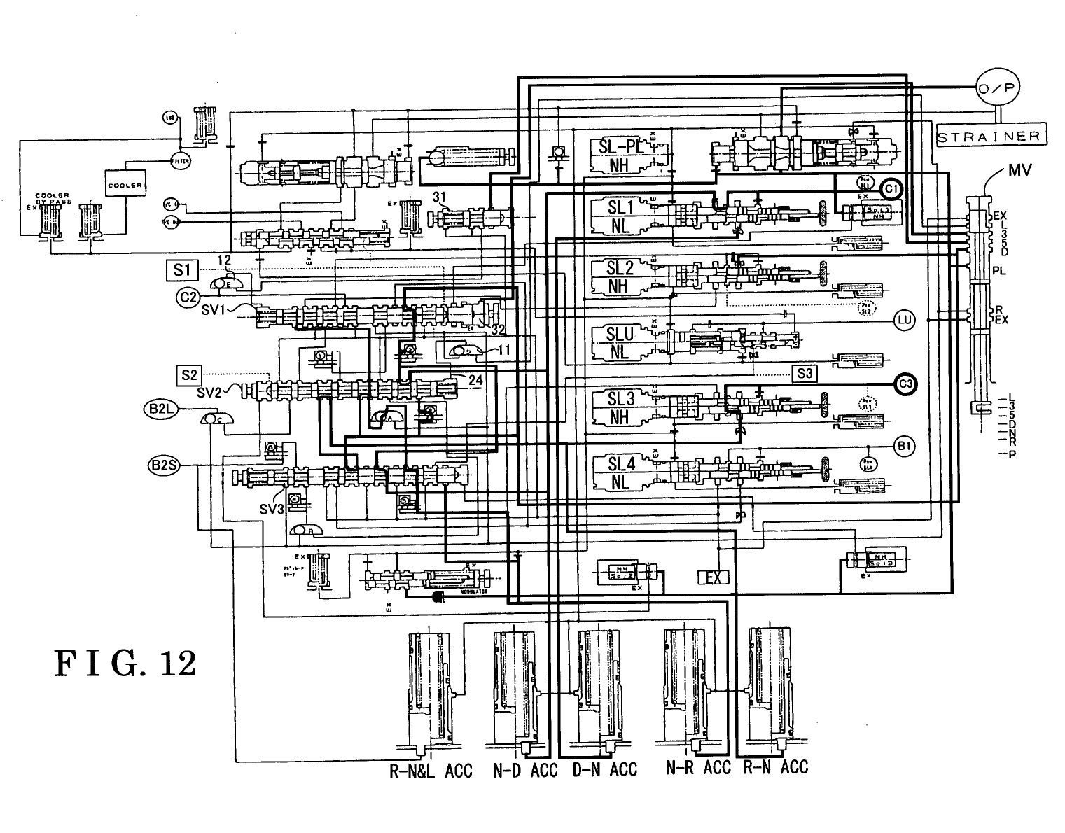

FIG. 12 illustrates a state of the oil passage configuration in which electric disconnection occurs at all lines while a vehicle is running at the 3rd shift range, i.e., while the solenoid valves S1, S2 and S3 are each at the OFF (X) state. As depicted by bold lines in FIG. 12, the manual valve MV outputs the 3rd range pressure as well as the D-range pressure and the 5th range pressure. The 3rd range pressure operates the change valve 31 so that the communication between the 5th range pressure and the compression coil spring chamber of the shift valve SV1 is discontinued. The 3rd range pressure further operates the separated-type small valve 32 which is positioned at the opposite side to the compression coil spring chamber of the shift valve SV1. As a result, the level of the 3rd range pressure becomes higher than the level of the pressure being applied to the compression coil spring chamber of the shift valve SV1, and so the shift valve SV1 is switched to the OFF (X) state.

Therefore, the solenoid valves S1, S2 and S3 are all turned to the OFF (X) state. As depicted by bold lines in FIG. 12, the D-range pressure of the manual valve MV retain the engagement of the clutch C1 and the clutch C3.

As described above, the clutch C1 (SL1) and the clutch C3 (SL3) are both engaged so that the 3rd shift stage is established in the transmission. Therefore, even if electric disconnection occurs at all lines while a vehicle is running at the 3rd shift stage, a vehicle running can be continued at the 3rd shift stage.

[Vehicle Driving at L-Range (1st Shift Stage)]

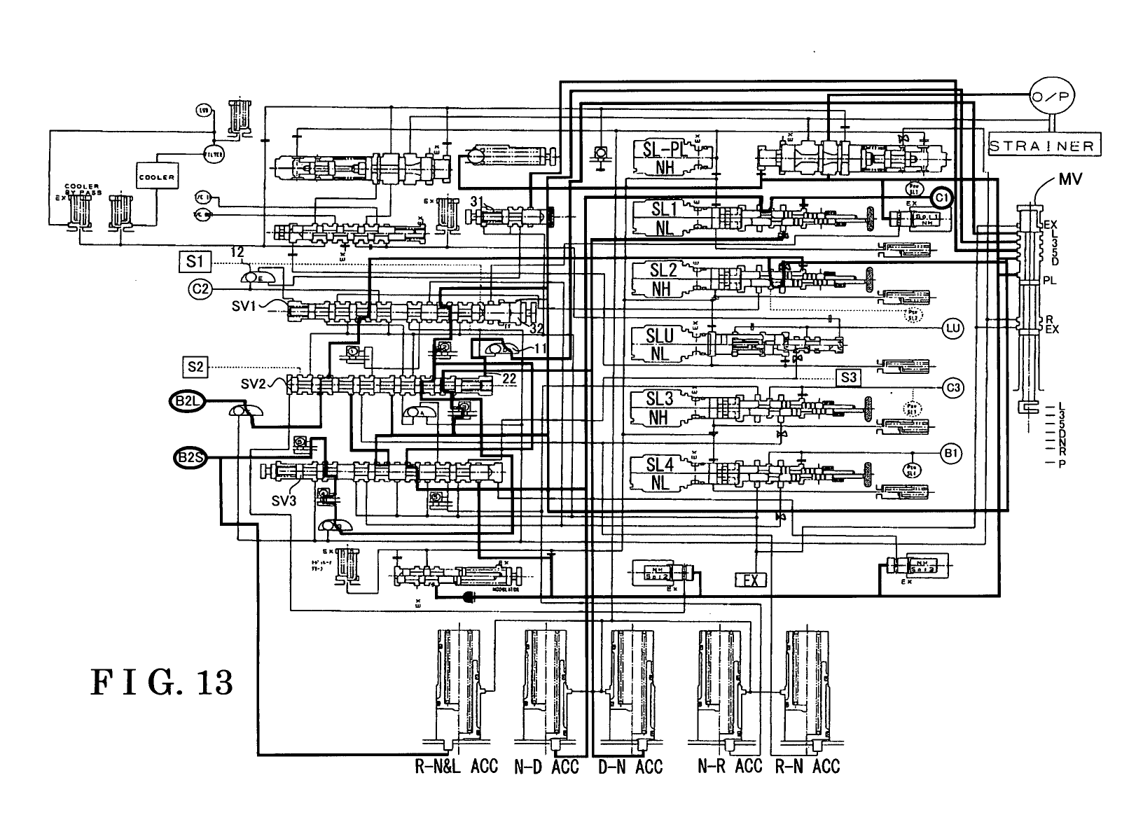

FIG. 13 illustrates a state of the oil passage configuration in which electric disconnection occurs at all lines while a vehicle is running at the L-range, i.e., while the solenoid valves S1 and S3 are each at the OFF (X) state and the solenoid valve S2 is at the ON (◯) state. As depicted by bold lines in FIG. 13, the manual valve MV outputs the L-range pressure as well as the D-range pressure, the 5th range pressure and the 3rd range pressure. The L-range pressure is introduced to the compression coil spring chamber of the shift valve SV2 via the shuttle valve 11 so that the shift valve SV2 is latched to the ON (◯) side.

Because the shift valve SV1 is switched to the OFF (X) state by the 3rd range pressure, the solenoid valves S1 and S3 are controlled at the OFF (X) state and the solenoid valve S2 is controlled at the ON (◯) state. As a result, as depicted by bold lines in FIG. 13, the D-range pressure of the manual valve MV retains the engagement of the clutch C1 and the brakes B2S and B2L.

Therefore, the clutch C1 (SL1), the brakes B2S and B2L (SL2, D-range pressure) are all engaged so that the 1st shift stage is maintained in the transmission. Therefore, even if electric disconnection occurs at all lines while a vehicle is running at the L-range, a vehicle running can be continued at the 1st shift stage.

As described above, against electric disconnection at all lines, while a vehicle is running in 1st-3rd shift stage of the D range under the automatic shift mode, an actual shift stage in the transmission is automatically controlled at the 3rd shift stage. Meanwhile, while a vehicle is running in the 4th-6th shift stage of the D range at the automatic shift mode, an actual shift stage in the transmission is automatically controlled at the 5th shift stage. Further, a vehicle can run at the 5th, 3rd or 1st shift stage by selectively switching a shift lever among the 5th, 3rd and L ranges in response to an operator's intention. Therefore, the oil pressure control apparatus according to the above-described embodiments enables assuring driving force required to start a vehicle at the 1st shift stage, speed acceleration at the 3rd shift stage, and a high-speed running at the 5th shift stage.

The present invention is not limited to the above-described embodiments and modifications. It is possible to make various changes, such as adding oil passages, controls, or the like, in accordance with specifications of automatic transmissions. For example, according to the above described embodiments, eight shift patterns, which are prescribed by the third power of two (2³) are assigned to two automatic shift modes and to all fixed shift stage modes. However, when one of the eight shift patterns is assigned to a single automatic shift mode, the other seven shift patterns can be assigned to seven fixed shift stages.

When a skip shift should be achieved during a vehicle driving at the 7th shift stage or more, the total quantity of linear solenoid valves, which activates the respective frictional engagement elements, are increased. In this case, the present invention is applicable, and the number of shift patterns is raised by increasing the number of shift valves, wherein reliability against failure can be improved.

Further, a conventional failure valve is configured to cut off an oil pressure for engaging a clutch. However, the basis of the embodiments of the present invention lies in fixing a shift pattern in accordance with a currently selected driving range or a vehicle driving condition. Therefore, the oil pressure control apparatus according to the embodiments of the present invention does not suffer from a complicated oil passage structure and is applicable to other types of multi-stage automatic transmissions with minor changes.

As described above, according to the present invention, it is possible to improve durability and reliability against disconnection failure in an automatic transmission in which a skip shift is achieved by directly controlling a level of oil pressure supplied from a hydraulic power source by use of control valves. Further, it is possible to maintain a vehicle driving at an appropriate shift stage when a failure is detected.

The principles, of the preferred embodiments and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. An oil pressure control apparatus for an automatic transmission including a plurality of frictional engagement elements engaged and disengaged so as to establish plural forward shift stages in combination of engagement and disengagement of the frictional engagement elements, the oil pressure control apparatus comprising:
a hydraulic power source for supplying oil pressure;
control valves for regulating a level of oil pressure supplied from the hydraulic power source and allocated for at least one corresponding frictional engagement element from among the frictional engagement elements, each control valve including an exhaust port for draining oil pressure supplied from the hydraulic power source and an output port for outputting oil pressure supplied from the hydraulic power source;
a plurality of shift valves shifted ON and OFF for selectively establishing an oil passage between each control valve and the corresponding frictional engagement element, wherein engagement and disengagement of the frictional engagement elements are controlled, combinations of the ON and OFF states of the shift valves allocated for an automatic shift pattern and a fixed shift pattern, the automatic shift pattern in which each control valve is operated so as to achieve an automatic shift mode by which a shift stage established in the transmission is freely selected from among the plural forward shift stages and the fixed shift pattern in which an oil passage for supplying oil pressure of the hydraulic power source to an exhaust port of a predetermined control valve from among the control valves via each shift valve is established so as to achieve a fixed shift mode by which a predetermined fixed forward shift stage is selected in the transmission;
a first latch circuit for maintaining a first predetermined shift valve from among the shift valves at a predetermined state by the oil pressure outputted through an output port of a first corresponding control valve from among the control valves when a predetermined high shift stage is established; and
a second latch circuit for maintaining a second predetermined shift valve from among the shift valves at a predetermined state by the oil pressure outputted through an output port of the first corresponding control valve when a predetermined shift stage for a vehicle restart is established.

2. An oil pressure control apparatus for an automatic transmission according to claim 1, comprising:
a third latch circuit for maintaining a third predetermined shift valve from among the shift valves at a predetermined state by a reverse range pressure supplied from a manual valve, a reverse shift pattern forcibly established via the third latch circuit when a reverse range is selected.

3. An oil pressure control apparatus for an automatic transmission according to claim 1, wherein output oil passages of the second latch circuit and the third latch circuit are connected to input ports of a shuttle valve, and an output port of the shuttle valve is connected to a valve chamber of each of the second and third predetermined shift valves.

4. An oil pressure control apparatus for an automatic transmission according to claim 2, wherein output oil passages of the second latch circuit and the third latch circuit are connected to input ports of a shuttle valve, and an output port of the shuttle valve is connected to a valve chamber of each of the second and third predetermined shift valves.

5. An oil pressure control apparatus for an automatic transmission according to claim 1, wherein plural fixed shift stages are selectively established under the fixed shift mode as well as the plural forward shift stages and a reverse shift stage under the automatic shift mode, the oil pressure control apparatus further comprising:
a manual valve for supplying oil pressure to an oil passage corresponding to each fixed shift stage, the manual valve being operated to contribute to establishing a predetermined fixed high shift stage among from the plural fixed shift stages, wherein an output passage of the manual valve communicates with the first latch circuit so that the predetermined fixed high shift stage is established under the fixed shift mode.

6. An oil pressure control apparatus for an automatic transmission according to claim 2, wherein plural fixed shift stages are selectively established under the fixed shift mode as well as the plural forward shift stages and a reverse shift stage under the automatic shift mode, and the manual valve supplies oil pressure to an oil passage corresponding to each fixed shift stage, the manual valve is operated to contribute to establishing a predetermined fixed high shift stage among from the plural fixed shift stages, wherein an output passage of the manual valve communicates with the first latch circuit so that the predetermined fixed high shift stage is established under the fixed shift mode.

7. An oil pressure control apparatus for an automatic transmission according to claim 3, wherein plural fixed shift stages are selectively established under the fixed shift mode as well as the plural forward shift stages and a reverse shift stage under the automatic shift mode, the oil pressure control apparatus further comprising:
a manual valve for supplying oil pressure to an oil passage corresponding to each fixed shift stage, the manual valve being operated to contribute to establishing a predetermined fixed high shift stage among from the plural fixed shift stages, wherein an output passage of the manual valve communicates with the first latch circuit so that the predetermined fixed high shift stage is established under the fixed shift mode.

8. An oil pressure control apparatus for an automatic transmission according to claim 4, wherein plural fixed shift stages are selectively established under the fixed shift mode as well as the plural forward shift stages and a reverse shift stage under the automatic shift mode, and the manual valve supplies oil pressure to an oil passage corresponding to each fixed shift stage, the manual valve is operated to contribute to establishing a predetermined fixed high shift stage among from the plural fixed shift stages, wherein an output passage of the manual valve communicates with the first latch circuit so that the predetermined fixed high shift stage is established under the fixed shift mode.

9. An oil pressure control apparatus for an automatic transmission according to claim 5, further comprising:
a change valve connected to the output passage of the manual valve when the predetermined fixed high shift stage is established,
wherein, when the manual valve is selectively operated to establish a predetermined fixed intermediate shift stage, the change valve is supplied with oil pressure and is operated to be closed and an oil passage to the first latch circuit is disconnected so that the predetermined fixed intermediate shift stage is established.

10. An oil pressure control apparatus for an automatic transmission according to claim 6, further comprising:
a change valve connected to the output passage of the manual valve when the predetermined fixed high shift stage is established,
wherein, when the manual valve is selectively operated to establish a predetermined fixed intermediate shift stage, the change valve is supplied with oil pressure and is operated to be closed and an oil passage to the first latch circuit is disconnected so that the predetermined fixed intermediate shift stage is established.

11. An oil pressure control apparatus for an automatic transmission according to claim 7, further comprising:
a change valve connected to the output passage of the manual valve when the predetermined fixed high shift stage is established,
wherein, when the manual valve is selectively operated to establish a predetermined fixed intermediate shift stage, the change valve is supplied with oil pressure and is operated to be closed and an oil passage to the first latch circuit is disconnected so that the predetermined fixed intermediate shift stage is established.

12. An oil pressure control apparatus for an automatic transmission according to claim 8, further comprising:
a change valve connected to the output passage of the manual valve when the predetermined fixed high shift stage is established,
wherein, when the manual valve is selectively operated to establish a predetermined fixed intermediate shift stage, the change valve is supplied with oil pressure and is operated to be closed and an oil passage to the first latch circuit is disconnected so that the predetermined fixed intermediate shift stage is established.

13. An oil pressure control apparatus for an automatic transmission according to claim 2, wherein plural fixed shift stages are selectively established under the fixed shift mode as well as the plural forward shift stages and a reverse shift stage under the automatic shift mode, and the manual valve supplies oil pressure to an oil passage corresponding to each fixed shift stage, the manual valve is operated to contribute to establishing a predetermined fixed low shift stage among from the plural fixed shift stages, wherein an output passage of the manual valve communicates with the second latch circuit so that the predetermined fixed low shift stage is established under the fixed shift mode.

14. An oil pressure control apparatus for an automatic transmission according to claim 3, wherein plural fixed shift stages are selectively established under the fixed shift mode as well as the plural forward shift stages and a reverse shift stage under the automatic shift mode, the oil pressure control apparatus further comprising:
a manual valve for supplying oil pressure to an oil passage corresponding to each fixed shift stage, the manual valve being operated to contribute to establishing a predetermined fixed low shift stage among from the plural fixed shift stages, wherein an output passage of the manual valve communicates with the first latch circuit so that the predetermined fixed low shift stage is established under the fixed shift mode.

15. An oil pressure control apparatus for an automatic transmission according to claim 4, wherein plural fixed shift stages are selectively established under the fixed shift mode as well as the plural forward shift stages and a reverse shift stage under the automatic shift mode, and the manual valve supplies oil pressure to an oil passage corresponding to each fixed shift stage, the manual valve is operated to contribute to establishing a predetermined fixed low shift stage among from the plural fixed shift stages, wherein an output passage of the manual valve communicates with the second latch circuit so that the predetermined fixed low shift stage is established under the fixed shift mode.

16. An oil pressure control apparatus for an automatic transmission according to claim 5, wherein plural fixed shift stages are selectively established under the fixed shift mode as well as the plural forward shift stages and a reverse shift stage under the automatic shift mode, the oil pressure control apparatus further comprising:
a manual valve for supplying oil pressure to an oil passage corresponding to each fixed shift stage, the manual valve being operated to contribute to establishing a predetermined fixed low shift stage among from the plural fixed shift stages, wherein an output passage of the manual valve communicates with the first latch circuit so that the predetermined fixed low shift stage is established under the fixed shift mode.

17. An oil pressure control apparatus for an automatic transmission according to claim 9, wherein plural fixed shift stages are selectively established under the fixed shift mode as well as the plural forward shift stages and a reverse shift stage under the automatic shift mode, and the manual valve supplies oil pressure to an oil passage corresponding to each fixed shift stage, the manual valve is operated to contribute to establishing a predetermined fixed low shift stage among from the plural fixed shift stages, wherein an output passage of the manual valve communicates with the second latch circuit so that the predetermined fixed low shift stage is established under the fixed shift mode.

18. An oil pressure control apparatus for an automatic transmission according to claim 10, wherein plural fixed shift stages are selectively established under the fixed shift mode as well as the plural forward shift stages and a reverse shift stage under the automatic shift mode, and the manual valve supplies oil pressure to an oil passage corresponding to each fixed shift stage, the manual valve is operated to contribute to establishing a predetermined fixed low shift stage among from the plural fixed shift stages, wherein an output passage of the manual valve communicates with the second latch circuit so that the predetermined fixed low shift stage is established under the fixed shift mode.

19. An oil pressure control apparatus for an automatic transmission according to claim 11, wherein plural fixed shift stages are selectively established under the fixed shift mode as well as the plural forward shift stages and a reverse shift stage under the automatic shift mode, and the manual valve supplies oil pressure to an oil passage corresponding to each fixed shift stage, the manual valve is operated to contribute to establishing a predetermined fixed low shift stage among from the plural fixed shift stages, wherein an output passage of the manual valve communicates with the second latch circuit so that the predetermined fixed low shift stage is established under the fixed shift mode.

20. An oil pressure control apparatus for an automatic transmission according to claim 12, wherein plural fixed shift stages are selectively established under the fixed shift mode as well as the plural forward shift stages and a reverse shift stage under the automatic shift mode, and the manual valve supplies oil pressure to an oil passage corresponding to each fixed shift stage, the manual valve is operated to contribute to establishing a predetermined fixed low shift stage among from the plural fixed shift stages, wherein an output passage of the manual valve communicates with the second latch circuit so that the predetermined fixed low shift stage is established under the fixed shift mode.
